(19) United States
(12) Patent Application Publication
(10) Pub. No.: US 2024/0329218 A1
(43) Pub. Date: Oct. 3, 2024

(54) REINIGUNGSSYSTEM FÜR EIN LIDARSENSORSYSTEM

(71) Applicant: Robert Bosch GmbH, Stuttgart (DE)

(72) Inventors: Janos Simonovics, Dunaharaszti (HU); Akos Hegyi, Mezöhegyes (HU); Bence Balint, Monor (HU); Gyorgy Szabo, Budapest (HU); Mate Hornyak, Pakozd (HU); Peter Deak, Budapest (HU); Zoltan Gyonyoru, Budapest (HU)

(21) Appl. No.: 18/617,827

(22) Filed: Mar. 27, 2024

(30) Foreign Application Priority Data
Mar. 31, 2023 (DE) 102023203051.9

(51) Int. Cl. G01S 7/497; B60S 1/06; B60S 1/56; G01S 17/931

(52) U.S. Cl. CPC G01S 7/497; B60S 1/06; B60S 1/56; G01S 17/931; G01S 2007/4977

(57) ABSTRACT

A cleaning system for a lidar sensor system, the cleaning system having a wiping unit, a drive, and an adjustment unit, wherein the drive is designed to move the wiping unit along a movement axis on a surface of the lidar sensor system, wherein the wiping unit is designed to wipe the surface of the lidar sensor system, wherein the adjustment unit is designed to move the wiping unit relative to the drive along a longitudinal direction perpendicular to the movement axis.

### BACKGROUND

The present invention relates to a cleaning device for a lidar sensor system. The invention also relates to a lidar sensor system with such a cleaning system and a vehicle with such a lidar sensor system.

Vehicles for moving in road traffic are constantly being further developed, wherein one direction of development is automated driving. The automated operation of a vehicle requires reliable environment monitoring in particular. This can be done in particular using lidar sensor systems.

Cleaning is necessary for lidar sensor systems to function reliably. Cleaning is carried out, for example, by compressed air and/or by spraying on a cleaning fluid.

### SUMMARY

The cleaning system according to the invention enables reliable cleaning of a lidar sensor system. In particular, a wiping unit is provided for cleaning, wherein the wiping unit can wipe over various shapes of cleaning surfaces.

The cleaning system for a lidar sensor has a wiping unit, a drive, and an adjustment unit. The drive is designed to move the wiping unit along a movement axis on a surface of the lidar sensor system. Thus, in particular, a first movement of the wiping unit is achieved. The wiping unit is designed to wipe the surface of the lidar sensor system. This ensures that the surface is cleaned by the wiping unit.

The adjustment unit is designed to move the wiping unit relative to the drive along a longitudinal direction perpendicular to the movement axis. This results in a second movement of the wiping unit in particular. The first movement and the second movement are preferably independent of each other, preferably oriented in different spatial directions. By superimposing the first movement and the second movement, different shapes of surfaces to be cleaned can be achieved. The cleaning system is therefore suitable for different surface shapes.

Preferably, the adjustment unit has a connecting element coupled to the drive. The connecting element can be moved along the longitudinal direction in relation to the drive. This results in two independent movements. The drive enables the connecting element to be moved along the movement axis, wherein the connecting element can also be moved along the longitudinal direction. The longitudinal direction is in particular perpendicular to the movement axis, so that any two-dimensional movement of the connecting element can be generated in relation to the surface to be cleaned. This ensures optimum cleaning of the surface.

The connecting element is particularly preferably located on a rail. The connecting element can be moved along the longitudinal direction relative to the drive by the rail when the connecting element is guided along the movement axis along the rail. The rail extends in particular along the movement axis and has different dimensions and/or elevations along the longitudinal direction, which generate a movement of the connecting element along the longitudinal direction.

Advantageously, the connecting element is in contact with the rail on one side. This means that the connecting element can be moved unidirectionally along the longitudinal direction by the rail. In this case, it is preferable for the connecting element to be preloaded in the direction of the rail and/or pressed against the rail by an elastic resetting element. Alternatively, the connecting element is in contact with the rail on both sides and can therefore be moved bidirectionally along the longitudinal direction. In this case, a preload and/or an elastic resetting element can be dispensed with. Active bidirectional movement of the connecting element along the longitudinal direction through the rail is also possible.

The connecting element is preferably preloaded into a predefined standard position relative to the drive via a resetting element. If the connecting element is not deflected along the longitudinal direction by the rail, the connecting element is returned to the standard position by the resetting element. The resetting element is in particular an elastically deformed element that exerts an elastic resetting force on the connecting element. The resetting element is a spring in particular.

A contact pressure element is preferably arranged between the connecting element and a wiper blade of the wiping unit. As a result, the wiper blade is pressed against a surface to be cleaned. This ensures that the wiper blade is always in reliable contact with the surface to be cleaned. This is particularly advantageous together with the movement along the longitudinal direction, even for different curvatures of the surface.

In a further embodiment, the drive and the wiping unit advantageously each have a magnet unit in order to adjust a relative position of the wiping unit with respect to the drive along the longitudinal direction. In particular, at least one magnet unit is an electromagnet, preferably to adjust the relative position continuously.

Furthermore, it is advantageously provided that the wiping unit can be pivoted relative to the drive about a pivot axis parallel to the movement axis. This means that the wiping unit can be adapted to different curvatures of the surface in particular.

The invention also relates to a vehicle comprising a lidar sensor system and a cleaning system as described above. The cleaning system is designed to clean such a surface of the lidar sensor system through which laser radiation can be emitted from the lidar sensor system and/or through which laser radiation can be received by the lidar sensor system.

The surface has a particularly advantageous curvature transverse to the movement axis. Thanks to the cleaning device, even the curved surface can be cleaned reliably.

### BRIEF DESCRIPTION OF THE DRAWINGS

In the following, exemplary embodiments of the invention are described in detail with reference to the accompanying drawing. The drawings show:

FIG. 1 a schematic view of a vehicle with a lidar sensor system according to an exemplary embodiment of the invention,

FIG. 2 a schematic view of a lidar sensor system with a cleaning system according to an exemplary embodiment of the invention,

FIG. 3 a further schematic view of the lidar sensor system with the cleaning system according to the exemplary embodiment of the invention,

FIG. 4a a first exemplary representation of a curvature of a surface of the lidar sensor system,

FIG. 4b a second exemplary representation of a curvature of a surface of the lidar sensor system,

FIG. 5 a further schematic view of the lidar sensor system with the cleaning system according to the exemplary embodiment of the invention,

FIG. 6a a schematic view of the lidar sensor system with the cleaning system according to the exemplary embodiment of the invention in a first state, and

FIG. 6b a schematic view of the lidar sensor system with the cleaning system according to the exemplary embodiment of the invention in a second state.

### DETAILED DESCRIPTION

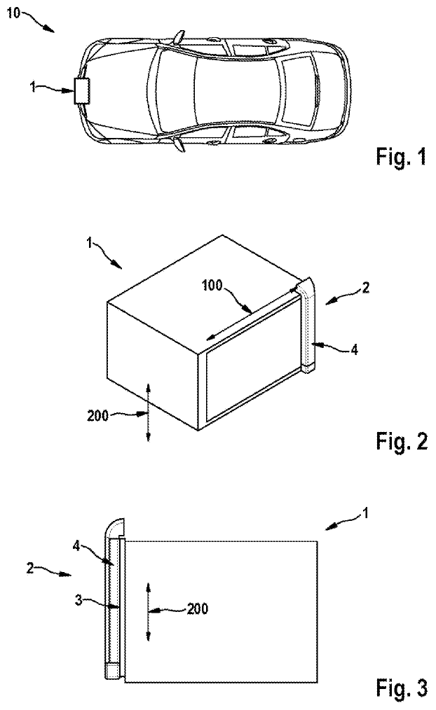

FIG. 1 schematically shows a vehicle 10 with a lidar sensor system 1. The vehicle 10 is designed in particular for automated driving. Reliable environment monitoring is provided by the lidar sensor system 1.

The lidar sensor system 1 according to the exemplary embodiment is shown schematically in different views in FIG. 2 and FIG. 3. To ensure that the lidar sensor system 1 functions reliably, cleaning is provided by a cleaning system 2, which cleans a surface 3. The cleaning system 2 is designed to clean such a surface 3 of the lidar sensor system 1, through which laser radiation can be emitted from the lidar sensor system 1 and/or through which laser radiation can be received by the lidar sensor system 1.

The cleaning system 2 has a wiping unit 4, which can be moved along a movement axis 100 along the surface 3 and is designed to wipe the surface 3. The surface 3 can be reliably cleaned by wiping off dirt from the surface 3 and/or by wiping off a previously applied cleaning fluid. This ensures that the lidar sensor system 1 is functional at all times, and in particular that the lidar sensor system 1 and thus the vehicle 10 can reliably detect the surroundings at all times.

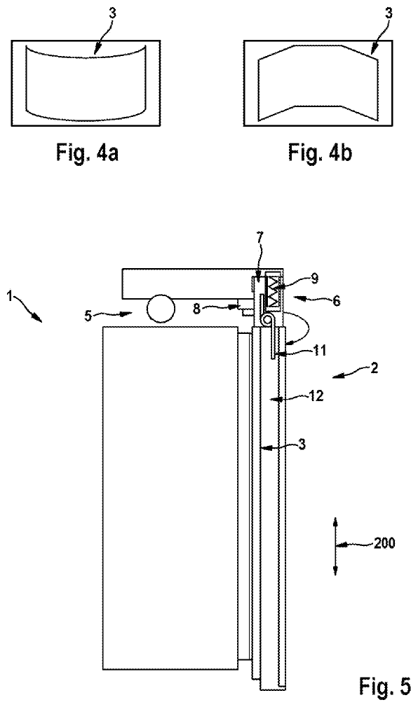

FIGS. 4a and 4b show special shapes of the surface 3. For example, as shown in FIG. 4a, the surface 3 can have a curvature in the vertical direction. The surface 3 can also be specially shaped, as shown as an example in FIG. 4b.

FIG. 5 schematically shows the lidar sensor system 1 with the cleaning system 2 according to the exemplary embodiment of the invention, wherein the cleaning system 2 is designed to clean surfaces 3 as shown by way of example in FIG. 4a or 4b.

The wiping unit 4 has a wiper blade 12, which is designed to be applied to the surface 3 and to wipe off dirt or fluid from the surface 3. A contact pressure element 11 ensures that the wiper blade 12 is pressed against the surface 3. This means that the wiper blade 12 lies reliably against the surface 3 and can therefore clean the surface 3 reliably.

In addition, the wiping unit 4 has a drive 5, which is shown in FIG. 5 by a guide and an element guided on the guide. The drive 5 can be used to perform a movement along the movement axis 100. In addition, the wiping unit 4 enables movement of the wiper blade 12 along the longitudinal direction 200 perpendicular to the movement axis 100 by means of an adjustment unit 6.

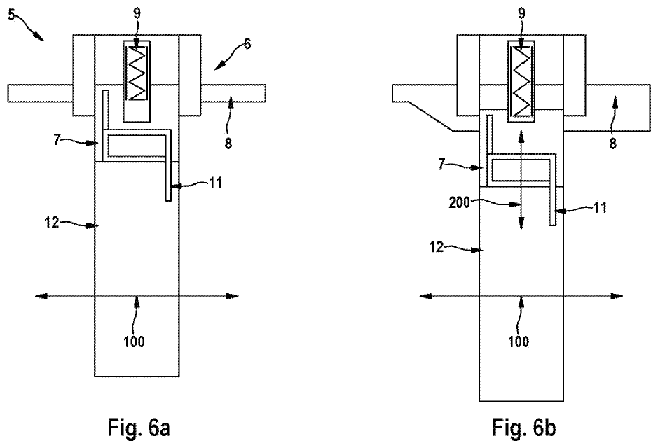

The adjustment unit 6 has a connecting element 7 coupled to the drive 5, which can be moved relative to the drive 5 along the longitudinal direction 200. The connecting element 7 rests against a rail 8, wherein the connecting element 7 is displaced relative to the drive 5 along the longitudinal direction 200 by the rail 8. This is shown as an example in FIGS. 6a and 6b.

In FIG. 6a, the connecting element 7 is not displaced and the rail 8 has a minimum dimension along the longitudinal direction 200. In FIG. 6b, the connecting element 7 is displaced along the longitudinal direction 200, as the rail 8 has an enlarged dimension along the longitudinal direction 200. In particular, the rail 8 has different dimensions along the movement axis 100, so that the connecting element 7 is moved along the longitudinal direction 200 when the connecting element 7 is guided along the movement axis 100 along the rail 8. In this way, the wiper blade 12 can also follow a curvature of the surface 3 as shown in FIGS. 4a and 4b.

The connecting element 7 is preloaded into a predefined standard position relative to the drive 5 via a resetting element 9. In particular, the resetting element 9 presses the connecting element 7 against the rail 8. This ensures that the connecting element 7 follows the rail 8 at all times or is in contact with the rail 8 at all times.

It was previously described that the connecting element 7 is in contact with the rail 8 on one side and is moved unidirectionally along the longitudinal direction 200 by the rail 8. Alternatively, it is also possible to place the connecting element 7 on both sides of the rail 8 and thus move it bidirectionally along the longitudinal direction 200 through the rail 8. In this case, there is forced guidance on the rail 8.

In a further alternative, a magnetic coupling between drive 5 and connecting element 7 is provided instead of the rail 8, wherein the connecting element 7 can be moved relative to the drive 5 via magnetic forces. This achieves the same mobility as described above with the rail 8.

1. A cleaning system (2) for a lidar sensor system (1), the cleaning system (2) comprising
a wiping unit (4),
a drive (5), and
an adjustment unit (6),
wherein the drive (5) is designed to move the wiping unit (4) along a movement axis (100) on a surface (3) of the lidar sensor system (1),
wherein the wiping unit (4) is designed to wipe the surface (3) of the lidar sensor system (1),
wherein the adjustment unit (6) is designed to move the wiping unit (4) relative to the drive (5) along a longitudinal direction (200) perpendicular to the movement axis (100).

2. The cleaning system (2) according to claim 1, wherein the adjustment unit (6) has a connecting element (7) which is coupled to the drive (5) and can be moved along the longitudinal direction (200) relative to the drive (5).

3. The cleaning system (2) according to claim 2, wherein the connecting element (7) is in contact with a rail (8), by means of which the connecting element (7) can be moved relative to the drive (5) along the longitudinal direction (200) when the connecting element (7) is guided along the movement axis (100) along the rail (8).

4. The cleaning system (2) according to claim 2, wherein the connecting element (7) is in contact on one side with the rail (8) and can be moved unidirectionally along the longitudinal direction (200) by the rail (8) or is in contact on both sides with the rail (8) and can be moved bidirectionally along the longitudinal direction (200).

5. The cleaning system (2) according to claim 2, wherein the connecting element (7) is preloaded into a predefined standard position relative to the drive (5) via a resetting element (9).

6. The cleaning system (2) according to claim 2, wherein a contact pressure element (11) is arranged between the connecting element (7) and a wiper blade (12) of the wiping unit (4) in order to press the wiper blade (12) against a surface (3) to be cleaned.

7. The cleaning system (2) according to claim 1, wherein the drive (5) and the wiping unit (4) each have a magnet unit in order to adjust a relative position of the wiping unit (4) with respect to the drive (5) along the longitudinal direction (200).

8. The cleaning system (2) according to claim 1, wherein the wiping device (4) can be pivoted relative to the drive (5) about a pivot axis (300) parallel to the movement axis (100).

9. A vehicle (10) having a lidar sensor (1) and a cleaning system (2) according to claim 1, wherein the cleaning system (1) is designed to clean such a surface (3) of the lidar sensor system (2) by means of which laser radiation can be emitted from the lidar sensor system (2) and/or by means of which laser radiation can be received by the lidar sensor system (2).

10. The vehicle according to claim 9, wherein the surface (3) has a curvature transverse to the movement axis (100).
